(19) United States
(12) Patent Application Publication
(10) Pub. No.: US 2005/0216856 A1
(43) Pub. Date: Sep. 29, 2005

(54) System and method for displaying information on an interface device

(76) Inventor: Michael C. Matti, Durham, NC (US)

Correspondence Address: John V. Biernacki;Jones Day, North Point, 901 Lakeside Avenue, Cleveland, OH, 44114, US

(21) Appl. No.: 10/806,553

(22) Filed: Mar. 23, 2004

(51) Int. Cl. G06F 3/00; G06F 17/21

(52) U.S. Cl. 715/768; 715/803; 715/797; 715/745; 715/764; 715/790; 715/808; 715/809; 715/804; 715/501.1; 715/513

(57) ABSTRACT

Systems and methods for displaying content of a web page to a user on a computing device. The content includes interactive one or more interface elements for display to a user and with which a user may normally interact. Instructions are provided for generating a protection component to overlay at least a portion of the web page content. Additional instructions are provided for receiving data indicative of an attempt at user interaction with an element from the web page. The generated protection component is used in preventing user interaction with the element from the web page.

### TECHNICAL FIELD

The present invention relates generally to computer-human interfaces and more particularly to displaying information to a user through an interface.

### BACKGROUND

Web content typically includes links and form controls for access by a user. However, there are situations where a static display, not interactivity, is desired for a web page having hyperlinks and other interface manipulable elements. For example, if a preview of time-sensitive, subscription-only content is needed, it would be helpful to display a version of the current home page in which the links and controls are inoperable.

Current approaches to preventing all or a portion of user interaction with a web page are inefficient. As an illustration, disabling a web page's features by modifying the page's Hypertext Markup Language (HTML) source would require an ongoing process of filtering and modification.

### SUMMARY

In accordance with the teachings provided herein, systems and methods are provided for displaying content of a web page to a user on a computing device. The content includes one or more interactive interface elements for display to a user and with which a user may normally interact.

As an example of a system and method, instructions are provided for generating a protection component to overlay at least a portion of the web page content. Additional instructions are provided for receiving data indicative of an attempt at user interaction with an element from the web page. The generated protection component is used in preventing user interaction with the element from the web page.

### BRIEF DESCRIPTION OF THE DRAWINGS

FIG. 1 is a block diagram depicting software and computer components for use in preventing interaction with a web page;

FIG. 2 is a block diagram depicting a wrapper page for use in preventing interaction with a web page;

FIG. 3 depicts a protected page configuration;

FIGS. 4-6 are graphical user interfaces providing an example of preventing interaction with a web page;

FIG. 7 is a flowchart depicting an operational scenario for invoking protected page functionality;

FIG. 8 is a flowchart depicting an operational scenario for preventing interaction with a target web page;

FIG. 9 is a flowchart depicting an operational scenario for handling mouse interaction with a protected web page; and

FIG. 10 is a block diagram depicting web server(s) that download instructions for preventing interaction with target web page content.

### DETAILED DESCRIPTION

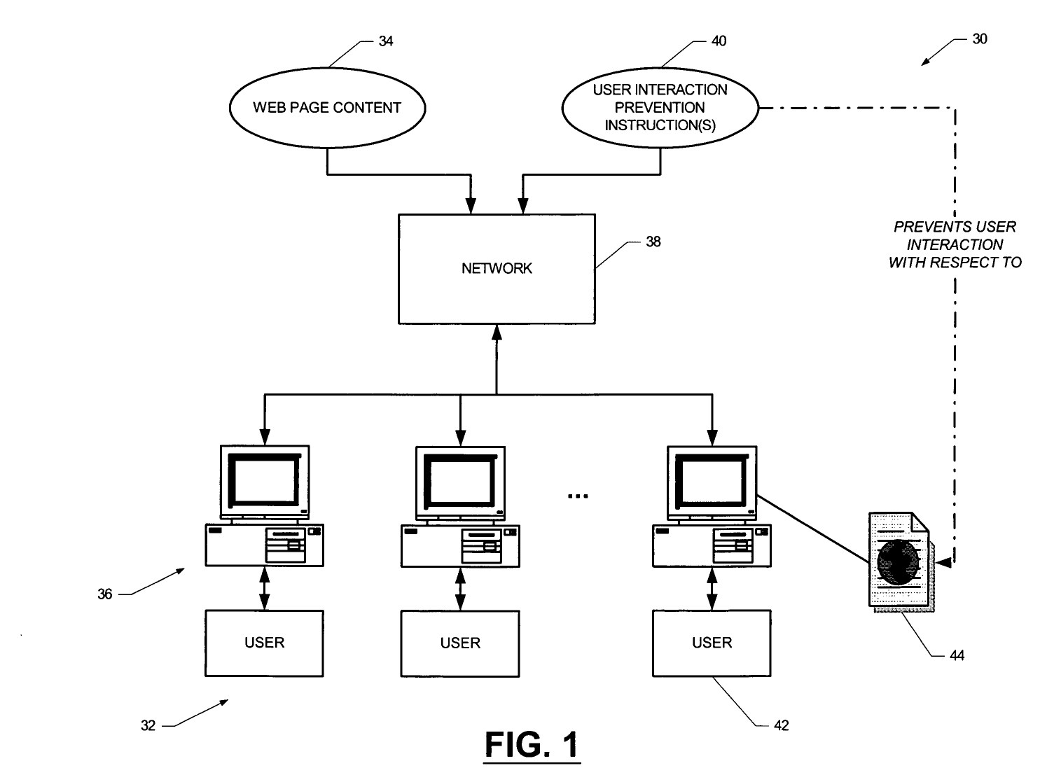

FIG. 1 depicts at 30 a system for displaying web pages to users 32, while preventing interaction with links and/or controls provided by the page content. The web page content 34 is provided to one or more user computers 36 over a network 38. Instruction(s) 40 to prevent interaction with the web page content 34 are also provided over the network 38.

Without the user interaction prevention instructions 40, a user (e.g., user 42) can access or activate a manipulable element/item on the displayed web page 44. With the user interaction prevention instructions 40, the user 42 is prevented from accessing or activating one or more manipulable elements on the displayed web page 44.

The content displayed on the web page 44 typically includes user manipulable elements, such as hyperlinks and form controls for access by a user. An example of a form control is a pull-down combo box wherein a user can select one or more data elements from the combo box.

The user interaction prevention instructions 40 include instructions for use on a user computer or other type of computing device, such as a hand-held personal digital assistant (PDAs) that is configured to display web page content. Any type of display software may be used to display the web page content received over a network, such as the Internet Explorer® web browser or Netscape Navigator® web browser.

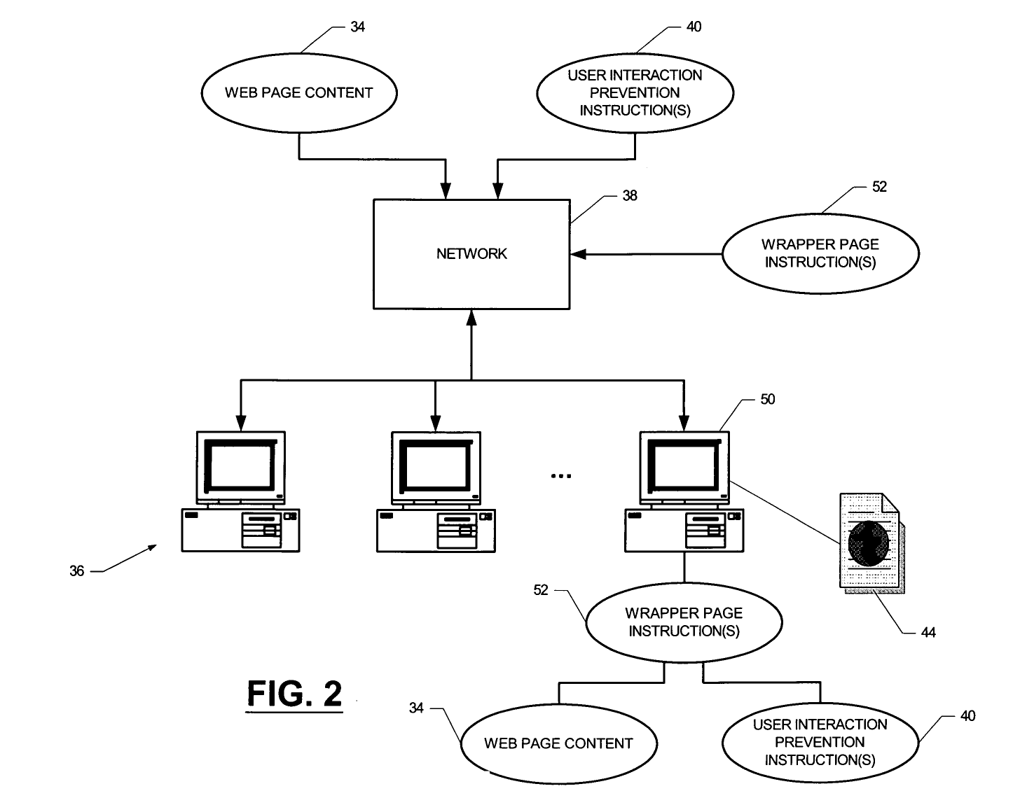

The user interaction prevention instructions 40 may be handled on a user computer in many different ways. For example, FIG. 2 shows wrapper page instructions 52 that are provided over a network 38 for specifying how the user interaction prevention instructions 40 and web content 34 are to be executed on a user computer. The user interaction prevention instructions 40 and the wrapper page instructions 52 may be delivered to the user computer 50 over the network 38 in a variety of ways. For example, the instructions 40 and 52 may be provided to the user computer 50 at about the time that the user computer has requested the web page content 34. Another example includes loading prevention instructions before multiple web pages are delivered so that the web pages may be viewed as a slide show.

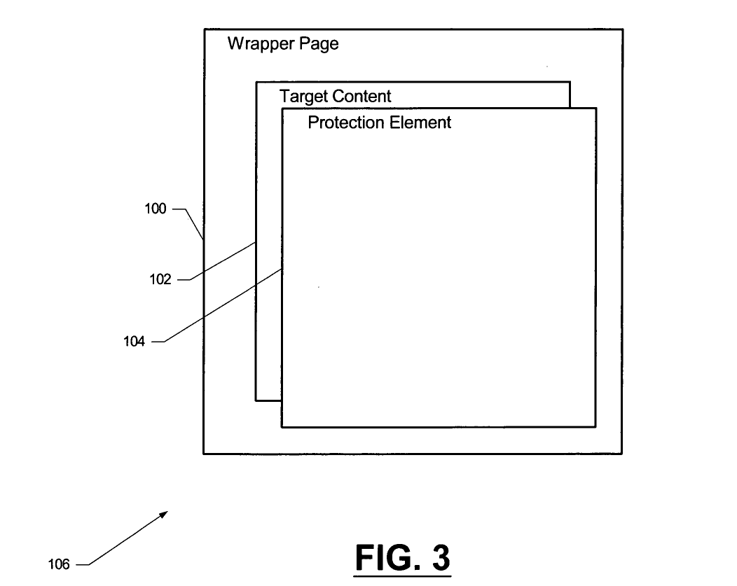

FIG. 3 depicts a wrapper page 100 that has been generated based upon wrapper page instructions. The wrapper page instructions load the target web page content 102 as a child, embedded page inside a previously created parent page (e.g., wrapper page 100). Wrapper page instructions can be configured to load the target web page content 102 within itself and then place on the display, directly in front of (e.g., above) the target content 102, a transparent protection element 104 that blocks interaction. This protected page configuration 106 renders the target web page content 102 behind a protection element 104 that acts like a shield by detecting and deflecting attempted access to the displayed web page content 102. The shielding action allows a static display to be provided, and not an interactive one, for the web page content 102. When interaction is attempted, a message could be displayed to the user indicating that user interaction has been prevented.

The protection element 104 may initially be transparent, translucent, or otherwise presented on the user's display device so as to allow the user to still view the web page content 102. The size of the protection element 104 may vary depending upon which region of the web page content 102 is to be protected. As an illustration, if all of the web page content 102 is to protected, then the size of the protection element 104 may be matched to the embedded target's size. The size of the protection element 104 may permit a gap for manipulation of the target's scroll bar(s). Still further, multiple protection elements may be placed in front of the web content 102 in order to protect different regions of the web content 102. This may be helpful to protect non-contiguous regions of the web content 102, thereby allowing user interaction with one or more regions of the web page 102, while preventing user interaction with other regions.

The shape of the protection element 104 may be rectangular or may be another shape (e.g., oval). The shape can be selected based upon a number of considerations, such as ease of programming in a particular coordinate system (e.g., rectangular) or which shape best covers the content region that needs protection. It should be understood that different shapes may be used at the same time to protect different regions of a displayed web page 102.

The “parent” wrapper page 100 may suppress all or several types of user interaction, such as suppressing tab key access to any links in the target content 102 as well as suppressing any attempt, using mouse input, to access the embedded content 102. If so configured, such attempts can result in the protection element 104 becoming more visible (e.g., changing from transparent to translucent, or from translucent to opaque) and displaying a feedback message to the user. Both the duration of visibility and text of the message are configurable.

The wrapper page 100 may perform other operations, such as displaying a banner, navigation, or any other web content. The banner may alert the user that interaction with the web page content has been prevented. It is also configurable whether the wrapper page 100 is displayed or is transparent to the user.

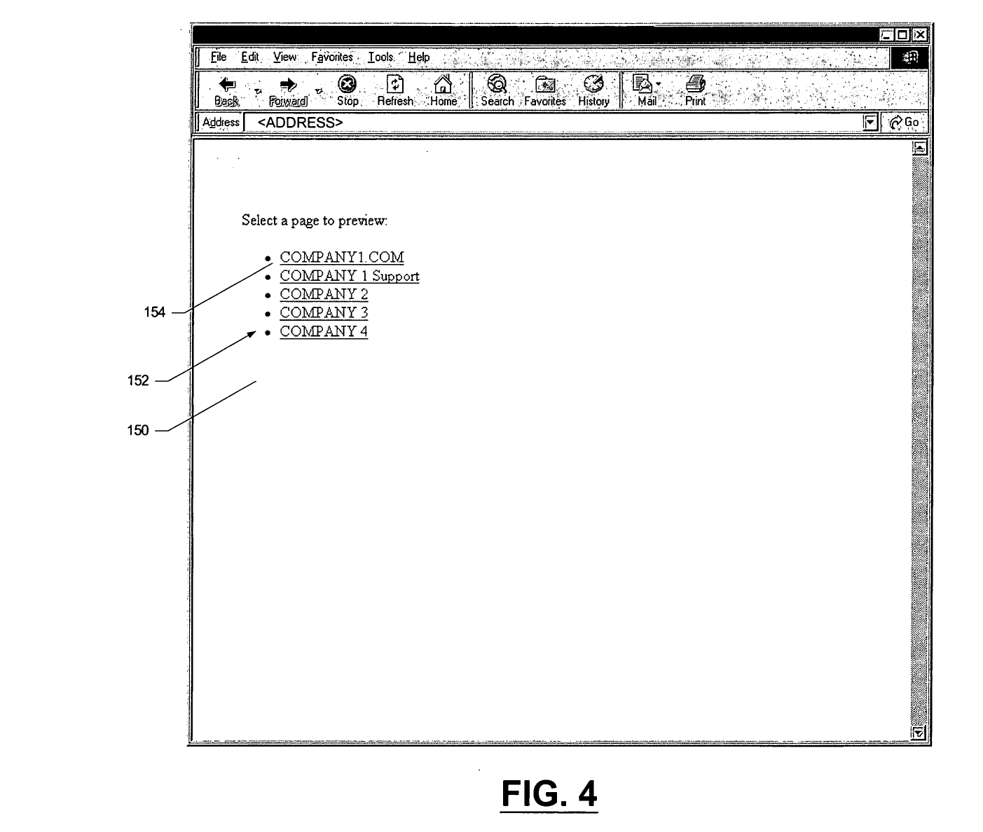

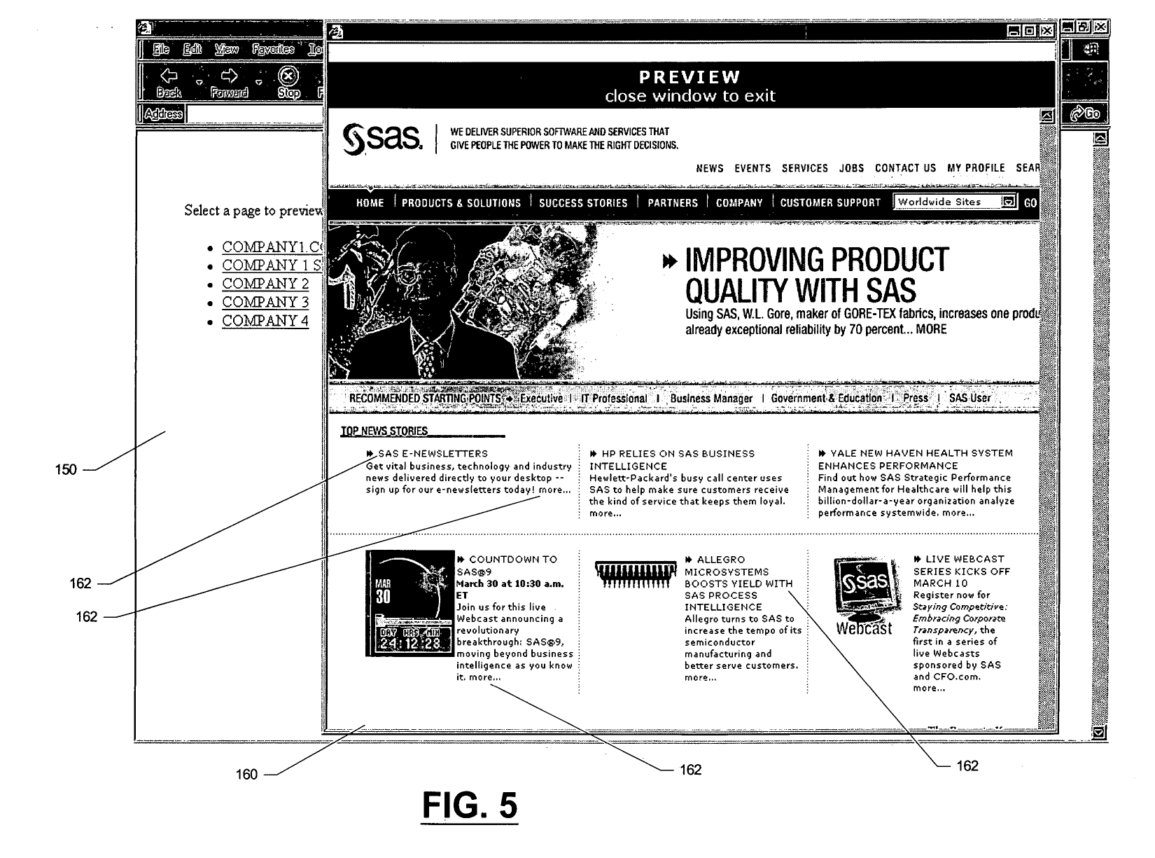

FIGS. 4-6 depict graphical user interfaces that provide an example of preventing interaction with a web page. FIG. 4 depicts a web page 150 with several hyperlinks 152 to other web pages. The other web pages may be on the same web site as web page 150 or on different web sites. In this example, a user selects the first hyperlink 154, thereby causing the web page of FIG. 5 to be displayed.

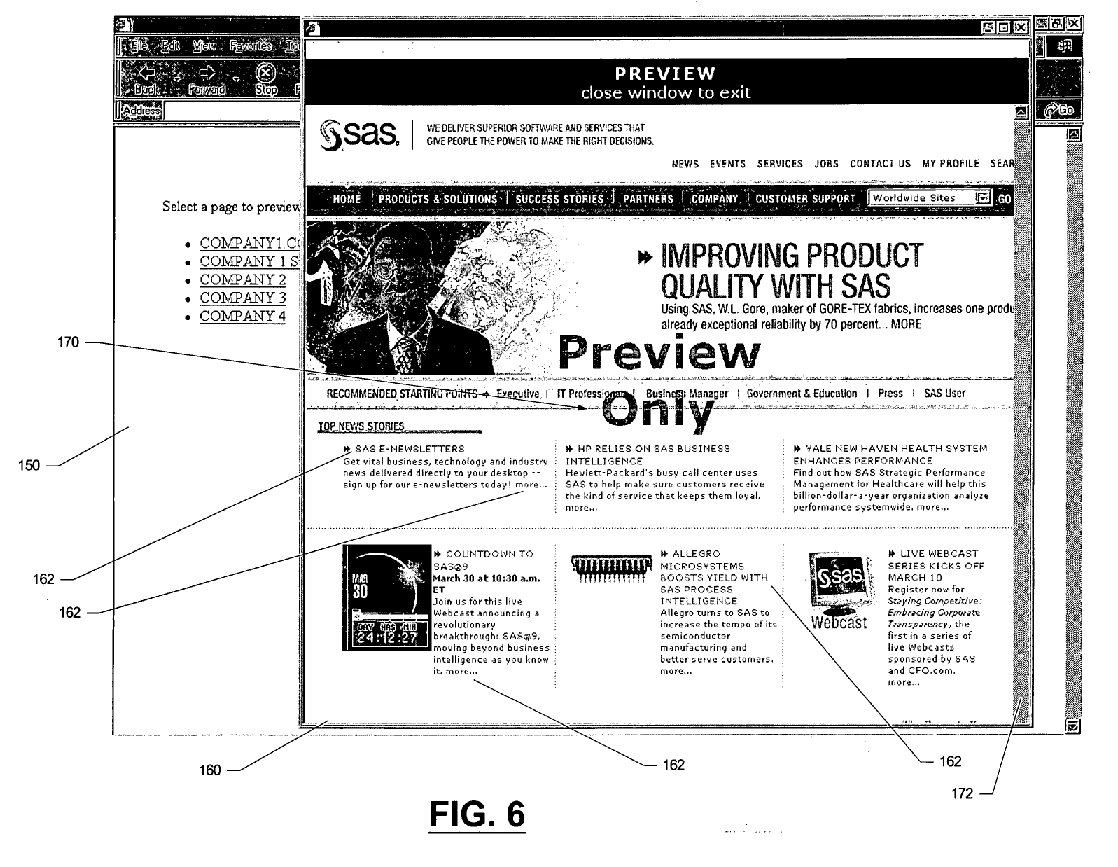

With reference to FIG. 5, wrapper page instructions have loaded web page content 160 and a protection element. In this example, the protection element is loaded as a transparent component in front of the web page content 160. The web page content 160 includes multiple hyperlinks 162. Normally, the web page 160 would allow a user to go to a particular web page by clicking one of the hyperlinks 162. However, if the user attempts to select one of the hyperlinks 162, the protection element prevents the interaction and displays a message 170 to the user such as the one shown in FIG. 6.

With reference to FIG. 6, the message 170 indicates that user interaction is being prevented and can provide a reason for why interaction is being prevented (e.g., “Preview Only”). Additional or different information may be provided within the message 170, such as contact information for a person that can address questions or issues from the user about the web page content and/or prevention of user interaction.

If a user continually attempts interaction with the web page content 160, then more prominent messages may be displayed to the user, such as a message “Preview Only” being even more prominently shown to the user and fading over a longer period of time as well as an audible beep or audio message. It should be understood that in addition to many different types of messages being able to be presented to the user, the system may also be configured so as not to present any message or indication that a protection element is being used. Additionally, the system can be configured to “kick off” (e.g., bar) the user from accessing the web site (or portions thereof) if the user persists in attempting to access the protected web page content.

The protection element may also be sized to allow the user to access the navigation scroll bar 172 associated with the web page content 160. This proper sizing allows the user to scroll the web page content 160 to see additional content while at the same time preventing user interaction with the web page content 160. It should be understood that the protection element may be configured to allow the user to access one or more of the hyperlinks on the web page 160 while denying interaction with the other hyperlinks. Also, if a user attempts to resize the window containing the web page content, then the protection element is automatically resized to cover the same proportionate area as it did before the resizing occurred.

A user interaction prevention system can be configured to allow a user to bypass the protection element. This would allow the user to interact with one or more portions of the web content. For example, a user may be presented not only with a message that user interaction is being prevented, but also with a prompt or user field for accepting a password. If the proper password is provided, then the protection element is deactivated, thereby allowing user interaction to occur (at least with that portion covered by the protection element). The user's computer system may also automatically provide user identification and/or password information to allow a bypass of the protection element. The system would check a user access list in order to determine whether the protection element should be deactivated for the user.

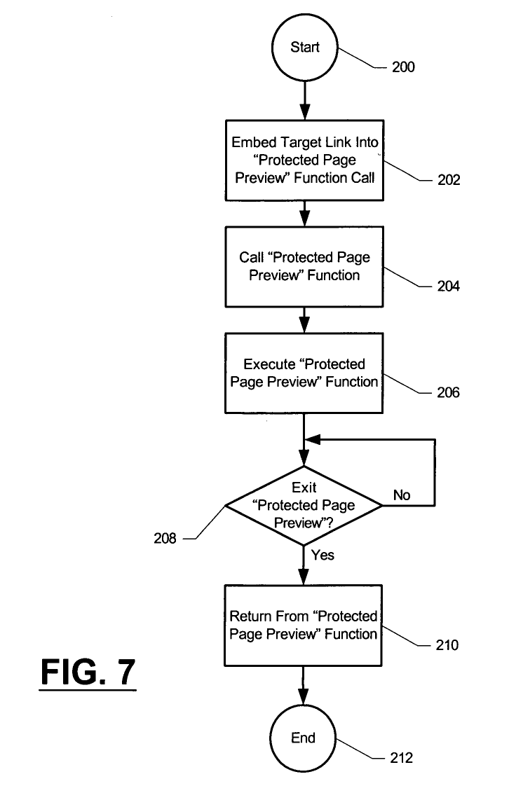

FIG. 7 depicts an operational scenario for invoking protected page functionality. Start block 200 indicates that the operational scenario begins at process step 202. At process step 202, a target link is embedded into a function call. When the function call is invoked at process step 204, the protected page preview function executes at process step 206.

User interaction is prevented with the content of a web page until decision step 208 determines whether the protected page preview has completed. For example, the protected preview function remains active, until the wrapper page is closed. If the protected preview has completed (e.g., the wrapper page is closed), then the protected page preview function returns at process step 210, and processing for this operational scenario terminates at end block 212.

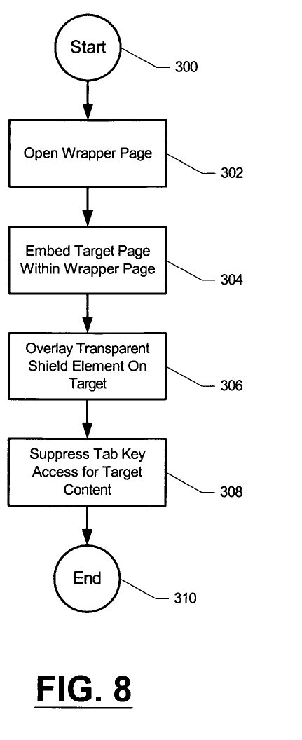

FIG. 8 shows greater details of the operational scenario with respect to a wrapper program loading target web page content. Start indication block 300 indicates that processing starts at process step 302. At process step 302, a wrapper page is opened. At process step 304, the target web page content is embedded into the wrapper page. A transparent shield element is overlaid on the target web page content at process step 306. At process step 308, the tab key is suppressed with respect to the target web page content. Processing for this operational scenario terminates at end block 310.

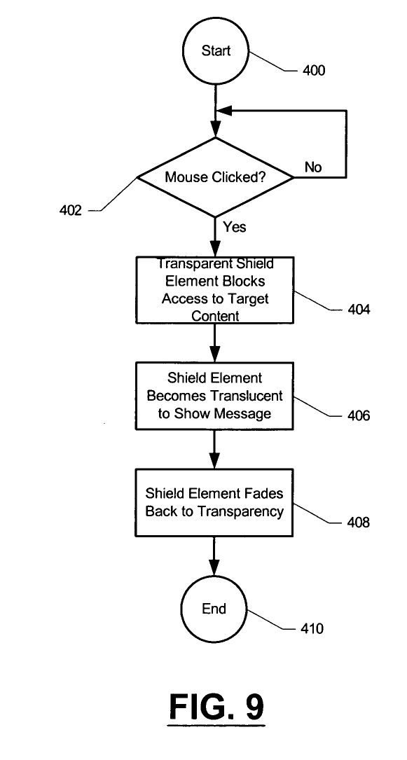

Other types of attempts at user interaction may also be suppressed. For example, FIG. 9 depicts an operational scenario for handling mouse interaction with a protected web page. As indicated by start block 400, decision step 402 examines whether a mouse click has occurred. If it has, then at process step 404 the transparent shield element blocks access to the target web page content. To indicate to the user that access is being blocked, the shield element becomes translucent at process step 406 in order to show a message to the user. The message indicates to the user that access is being prevented. After the message has been displayed, the shield element fades back to transparency at process step 408. The system resets to intercept the next mouse click. Processing for this scenario terminates at end block 410. It should be understood that similar to the other processing flows described herein, the steps and the order of the steps in the flowchart may be altered, modified and/or augmented and still achieve the desired outcome.

It should also be understood that such processing may be used in many different applications. For example, the disclosed processing flows may be used if a preview of time-sensitive, subscription-only content is needed. In this application example, a version of the current home page is displayed in which the links and controls are rendered inoperable by shielding the original page from keyboard or mouse interaction. In this way, web sites that offer frequently updated, commercial content, with a limited view of top-level pages can be provided to unregistered users.

As another example, in Web portals and applications, the disclosed processing flows provide the ability for users to customize screen content and allow a preview to other users without allowing user interaction. The processing flows allow a display of unaltered content behind a shield that deflects interaction. In this way, end-users can confirm their choices without risk of being drawn from their location in the site.

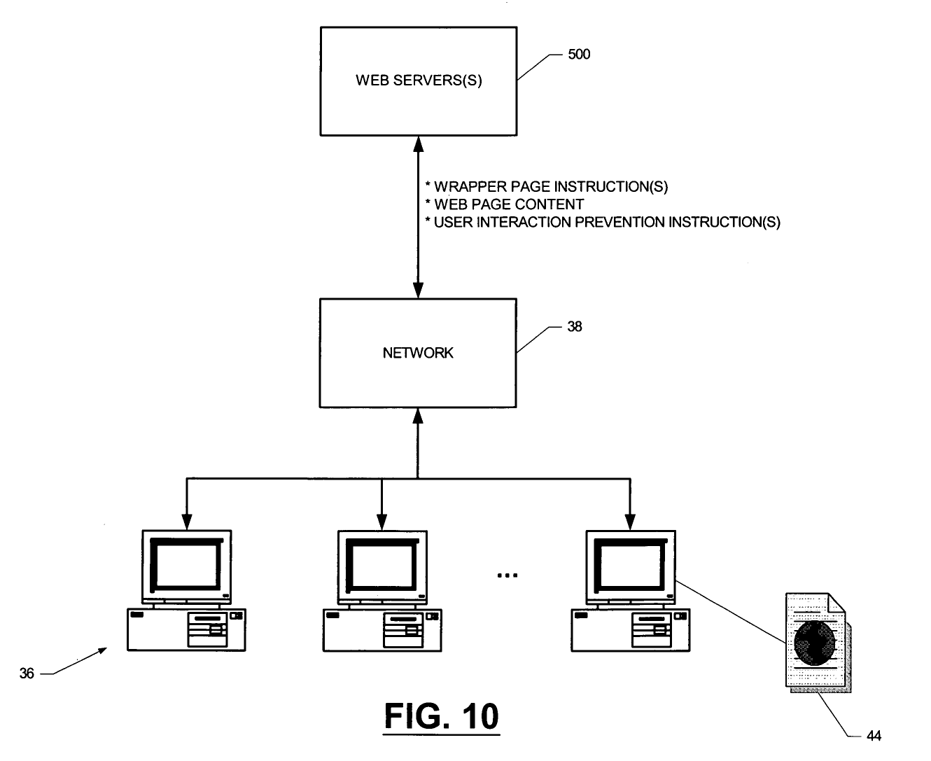

The disclosed systems and processing flows may be used in many different computer architectures. For example, FIG. 10 illustrates that one or more web server(s) 500 can be used to download the different instructions for preventing interaction with target web page content. The same web server or different web servers may provide the instructions and the web page content to the requesting user over the network 38. Moreover, a web server can be configured so as to dynamically generate the web page content based upon a user request. However, it should be understood that the web page content may not be dynamically generated in order to handle the user's request.

While examples have been used to disclose the invention, including the best mode, and also to enable any person skilled in the art to make and use the invention, the patentable scope of the invention is defined by claims, and may include other examples that occur to those skilled in the art. For example, the systems and methods described herein may be implemented using a variety of Web technologies, including ActiveX, ASP (Active Server Page), Java, Javascript, and PHP (PHP: Hypertext Preprocessor). As an illustration, HTML and Javascript may be used as follows.

In the following example, two web pages are used to construct previews: protprevlist.html which loads a wrapper page; and protprevwrap.html, which in turn loads target content.

PROTPREVLIST.HTML

HREF links on this page call the Javascript function preview( ), which embeds the link location within the URL that loads protprevwrap.html.

< html><head><title>Protected Page Previews</title>
<script type=“text/javascript”><!--
function preview(loc){

window.open(‘protprevwrap.html’+’?’+

loc,’_preview’,’menubar=no,toolbar=no,resizable=yes’);}

//--></script>
</head><body>
<blockquote><br />
Select a page to preview:
<ul>
<li><a href=
“javascript:preview(‘http://www.sas.com’)”>SAS.COM</a></li>
<li><a href=
“javascript:preview(‘http://support.sas.com’)”>SAS Support</a>
</li>
<li><a href=“javascript:preview(‘http://www.sap.com’)”>SAP</a></li>
<li><a href=
“javascript:preview(‘http://www.oracle.com’)”>Oracle</a></li>
<li><a href=
“javascript:preview(‘http://www.redhat.com’)”>Red Hat</a></li>
</ul>
</blockquote>
</body></html>

PROTPREVWRAP.HTML

When protprevwrap.html is loaded, it extracts the target location from the current address by reading the string following the character ? in the URL. The target content is then loaded within an IFRAME element. A negative TABINDEX value for the IFRAME element prevents the user from tabbing focus to the protected content.

A DIV element is positioned above the IFRAME and its opacity is set to 0%. This renders the DIV element invisible, but still sensitive to mouse clicks. The shield has a width of 98% and is aligned flush-left, to allow access to the target content's scroll bar.

Left or right clicks on the invisible shield DIV are intercepted by ONMOUSEDOWN and ONCONTEXTMENU events, which call the Javascript function warn( ). The warn( ) function resets the shield opacity to the value of the variable opac, which causes the previously invisible DIV to become translucent, displaying a feedback message to the user. The function fade( ) then causes the message to disappear, by resetting its opacity back to 0% in the increments defined by fadestep and the speed defined by faderate.

<html><head><title>Protected Web Page Preview</title>
<style><!--
body{

margin:0;}

div#prevban{

color:#fff;
background-color:#039;
font-family:verdana;
font-weight:bold;
text-align:center;
padding:.5ex;
border-bottom:1px solid #fff;}

div#banmain{

font-size:medium;
letter-spacing:.2ex;}

div#bansub{

font-size:small;}

iframe#embed{

text-align:center;
border-bottom:1px solid #ccc;
position:absolute;
height: 100%;
width:100%;}

div#shield{

color:#000;
background-color:#fff;
font-family:verdana;
font-size:xx-large;
font-weight:bold;
text-align:center;
padding-top:30%;
position:absolute;
height: 100%;
width:98%;
-moz-opacity:0;
filter:alpha(opacity=0);}

//--></style>
<script type=“text/javascript”><!--
var shield=warnintr=null;
var opac=oplev=40;
var warntime=750;
var fadestep=4;
var faderate=50;
if(!document.all){

opac=opac/100;
fadestep=fadestep/100;}

if(location.search.length>0){

target=‘<iframe id=“embed” tabindex=“−1”
frameborder=“0” scrolling=“yes”‘+

‘ src=“‘+location.search.substring(1)+’”></iframe>‘;}

function fade( ){

oplev−=fadestep;
if(oplev>0)

document.all?shield.filter=‘alpha(opacity=‘+oplev+’)’:

shield.MozOpacity=oplev;

else{

document.all?shield.filter=‘alpha(opacity=0)’:

shield.MozOpacity=0;

clearInterval(warnintr);}}

function warn( ){

if(document.getElementById){

shield=document.getElementById(‘shield’).style;
document.all?shield.filter=‘alpha(opacity=‘+opac+’)’:

shield.MozOpacity=opac;

clear Interval(warnintr);
oplev=opac;
setTimeout(‘warnintr=
setInterval(“fade( )”,faderate)’,warntime);}}

window.focus( );
//--></script>
</head>
<body>
<div id=“prevban”>
<div id=“banmain”>PREVIEW</div>
<div id=“bansub”>close window to exit</div>
</div>
<script type=“text/javascript”><!--
document.write(target);
//--></script>
<div id=“shield” onmousedown=“warn( );return false”

oncontextmenu=“warn( );return false”>

Preview<br />Only</div>
</body></html>

It should be understood that this example may be modified and extended in many different ways. As an illustration, the example can be modified to prevent viewing the targeted content directly. The target addresses may be provided by a compiled component, such as a Java applet, or can be obfuscated in the HTML source. For example, the character string representing a target address could be replaced with hexadecimal Unicode characters. This would cause the URL address http://www.sas.com/ to appear as:
\u0068\u0074\u0074\u0070\u003a\u002f\u002f\u0077\u0077\u0077\u002e\u0073\u0061\u0073\u002e\u0063\u006f\u006d\u002f
   Still further other techniques may be used, such as encryption.

It is further noted that the systems and methods disclosed herein may be implemented on various types of computer architectures, such as for example on a network (e.g., local area network, wide area network, or internet), or in a client-server configuration, or in an application service provider configuration. In multiple computer systems, data signals related to the systems and methods disclosed herein may be conveyed via fiber optic medium, carrier waves, wireless networks, etc. for communication among computers.

The systems' and methods' data may be stored as one or more data structures in computer memory and/or storage depending upon the application at hand. The data structures describe formats for use in storing data on computer-readable media or use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The systems and methods may also have their information transmitted via data signals embodied on carrier signals (e.g., radio frequency carrier signals) or other communication pathways (e.g., fiber optics, infrared, etc.).

The computer components, software modules, functions and data structures described herein may be connected directly or indirectly to each other in order to allow the flow of data needed for their operations. It is also noted that a module includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. Also, the systems and methods may provide a protection element for other programming environments, such as forms or user interfaces that appear in a data mining application or a Microsoft Windows-type application, such as the Microsoft Access® database product. A software program operable with Microsoft Access® can implement the protection element functionality in order to have a protection element overlay the form (or portion thereof) that is to be protected.

1. A system for displaying content of a web page to a user on a computing device, wherein the computing device includes a processor to execute instructions, wherein the content includes an interactive interface element for display to a user, comprising:
one or more first instructions for generating a protection component to overlay at least a portion of content of the web page;
one or more second instructions for receiving data indicative of an attempt at user interaction with an element from a web page;
wherein the overlaid portion covers the element from the web page;
wherein the generated protection component is used in preventing user interaction with the element from the web page.

2. The system of claim 1, wherein the protection component shields the web page from interaction with an interface pointing device;
wherein instructions are used to prevent keyboard interaction with the web page.

3. The system of claim 1, wherein the protection component acts as a shield in preventing user interaction with a plurality of elements displayed on the web page.

4. The system of claim 1, wherein the element is a hyperlink

5. The system of claim 1, wherein the element is a user manipulable control.

6. The system of claim 1, wherein the element is a web page form control element.

7. The system of claim 6, wherein the web page form control element is a combo box with which the web page by itself allows a user to interact with the web page form control element in order to select data provided by the combo box; wherein the protection component renders the web page combo box inoperable to the user.

8. The system of claim 1 further comprising:
one or more third instructions for loading the web page content as a child, embedded page inside a wrapper page;
wherein the third instructions place in front of the web page content the protection component on a computing device's display unit.

9. The system of claim 1, wherein the third instructions place the protection component as a transparent element directly in front of the web page content on a computing device's display unit.

10. The system of claim 9, wherein size of the transparent element is at least substantially matched to the embedded web page content.

11. The system of claim 1, wherein the protection component is configured to cover on a computing device's display the displayed web page content such that the user can access a navigation region associated with the web page content.

12. The system of claim 11, wherein the navigation region includes a scroll-up and scroll-down navigation section of the displayed web page content.

13. The system of claim 1, wherein when interaction with the web page content is attempted by the user, the overlaid protection component presents a message to the user that notifies the user that interface access is being prevented.

14. The system of claim 1, wherein when interaction with the web page content is attempted by the user, a visibility characteristic of the overlaid protection component is changed.

15. The system of claim 1, wherein the visibility characteristic changes such that the overlaid protection component become more opaque.

16. The system of claim 1, wherein the web page content is to be displayed through use of a web browser operating on a computing device.

17. The system of claim 1, wherein the web page content is for display upon a computing device that is capable of displaying web page content to a user.

18. The system of claim 17, wherein the web page content is for display upon a computer to a user.

19. The system of claim 17, wherein the web page content is for display upon a personal digital assistant (PDA) device that is capable of displaying web page content to a user.

20. The system of claim 1, wherein first instructions are based upon instructions selected from the group of Hypertext Markup Language (HTML) instructions, ActiveX instructions, ASP (Active Server Page) instructions, Java instructions, Javascript instructions, PHP (PHP: Hypertext Preprocessor) instructions, and combinations thereof.

21. The system of claim 1, wherein the first instructions comprise machine code instructions.

22. The system of claim 1, wherein the first instructions comprise human-readable instructions.

23. The system of claim 1, wherein the web page content is loaded within a Hypertext Markup Language (HTML) IFRAME element;
wherein an HTML DIV element is positioned above the IFRAME element and its opacity value is set so as to render the DIV element transparent or at least substantially translucent and capable of preventing user interaction with at least a portion of the web page content.

24. The system of claim 1, wherein the user gains access to the web page content so as to be able to interact with the element from the web page based upon password information being provided;
wherein access for the user to the web site containing the web page content is barred if the user attempts to access the web page content more than a predetermined number of times.

25. The system of claim 1, wherein the web page content and the first and second instructions are provided to a computing device over a network.

26. The system of claim 25, wherein the network is an internet network.

27. The system of claim 25, wherein the network is a wide area network or a local area network.

28. The system of claim 25, wherein a network address is associated with the web page content, wherein an obfuscated version of the address is displayed to the user.

29. The system of claim 1, wherein web page instructions indicate how the web page content is to be displayed to a user, wherein the web page instructions allow the element to be manipulated while the element is to be displayed to a user;
wherein the preventing of the user interacting with the element by the first instructions does not require modification of the web page instructions in order to prevent the user interaction with the element.

30. The system of claim 1, wherein web page Hypertext Markup Language (HTML) instructions indicate how the web page content is to be displayed to a user, wherein the web page HTML instructions allow the element to be manipulated while the element is to be displayed to a user;
wherein the preventing of user interaction with the element by the first instructions does not require modification of the web page HTML source code in order to prevent the user interaction with the element.

31. The system of claim 1, wherein a storage device, which is remotely located from the computing device and accessible by the computing device over a network, stores the first instructions.

32. The system of claim 1, wherein a storage device of the computing device stores the first instructions for use by the computing device.

33. A method for displaying content of a web page to a user on a computing device, wherein the computing device includes a processor to execute instructions, wherein the content includes an interactive interface element for display to a user, comprising the steps of:
generating a protection component to overlay at least a portion of the web page content;
receiving data indicative of an attempt at user interaction with an element from the web page;
wherein the overlaid portion covers the element from the web page;
wherein the generated protection component is used in preventing user interaction with the element from the web page.

34. A system for displaying content of a web page to a user on a computing device, wherein the computing device includes a processor to execute instructions, wherein the content includes an interactive element for display to a user, comprising:
means for generating a protection component to overlay at least a portion of the web page content;
means for receiving data indicative of an attempt at user interaction with an element from a web page;
wherein the overlaid portion covers the element from the web page;
means for loading the web page content as a child, embedded page inside a wrapper page, and for placing the protection component in front of the web page content;
wherein the generated protection component is used in preventing user interaction with the element from the web page.

35. A method for displaying content of a web page to a user on a computing device, wherein the computing device includes a processor to execute instructions, wherein the content includes an interactive interface element for display to a user, comprising:
providing one or more first instructions for generating a protection component to overlay at least a portion of the web page content;
providing one or more second instructions for handling data indicative of an attempt at user interaction with an element from a web page;
wherein the overlaid portion covers the element from the web page;
wherein the generated protection component is used in preventing user interaction with the element from the web page.

36. A system for displaying content of a web page to a user on a computing device, wherein the computing device includes a processor to execute instructions, wherein the content includes an interactive interface element for display to a user, comprising:
means for providing one or more first instructions for generating a protection component to overlay at least a portion of the web page content;
means for providing one or more second instructions for handling data indicative of an attempt at user interaction with an element from a web page;
wherein the overlaid portion covers the element from the web page;
means for providing one or more third instructions for loading web page content as a child embedded page inside a wrapper page, and for placing the protection component in front of the web page content;
wherein the generated protection component is used in preventing user interaction with the element from the web page.

37. Computer software stored on a computer readable media, the computer software comprising program code for carrying out a method for displaying content of a web page to a user on a computing device, wherein the computing device includes a processor to execute instructions, wherein the content includes an interactive interface element for display to a user, comprising the steps of:
generating a protection component to overlay at least a portion of the web page content;
receiving data indicative of an attempt at user interaction with an element from a web page;
wherein the overlaid portion covers the element from the web page;
wherein the generated protection component is used in preventing user interaction with the element from the web page.

38. A computer data signal transmitted over a network, wherein the data signal includes first and second instructions for use in handling content of a web page to a user on a computing device, wherein the computing device includes a processor to execute instructions, wherein the content includes an interactive interface element for display to a user;
wherein the first instructions are for generating a protection component to overlay at least a portion of the web page content;
wherein the second instructions are for receiving data indicative of an attempt at user interaction with an element from a web page;
wherein the overlaid portion covers the element from the web page;
wherein the generated protection component is used in preventing user interaction with the element from the web page.

39. A system for displaying content of a form to a user on a computing device, wherein the computing device includes a processor to execute instructions, wherein the content includes an interactive interface element for display to a user, comprising:
one or more first instructions for generating a protection component to overlay at least a portion of content of the form;
one or more second instructions for receiving data indicative of an attempt at user interaction with an interface element from the form;
wherein the overlaid portion covers the interface element from the form;
wherein the generated protection component is used in preventing user interaction with the element from the form.

40. The system of claim 39, wherein the form is generated from a database product.

41. The system of claim 39, wherein the form is a web-based form.

42. The system of claim 39, wherein the form is generated in order to interact with a data mining application.
